(19) United States
(12) Patent Application Publication
(10) Pub. No.: US 2003/0084136 A1
(43) Pub. Date: May 1, 2003

(54) System and method for device specific identification and management of network devices

(76) Inventor: Jayanta Tewari, Austin, TX (US)

Correspondence Address: BAKER BOTTS L.L.P., PATENT DEPARTMENT, 98 SAN JACINTO BLVD., SUITE 1500, AUSTIN, TX, 78701-4039, US

(21) Appl. No.: 10/002,645

(22) Filed: Oct. 31, 2001

(51) Int. Cl. G06F 15/173

(52) U.S. Cl. 709/223; 709/220

(57) ABSTRACT

The present invention discloses a system and method are described for communicating information that includes multiple network devices that each having at least one network communication port. Each network device is connected to other network device through the communication port. One or more of the network devices is also coupled to an advanced manager through the network device communication port. The advanced manager serves to determine the functionality of the least one network device via the communication port and manage the network device based upon its functionality.

### TECHNICAL FIELD

The present invention relates in general to the field of networks and more specifically to a system and method for device specific identification and management of network devices.

### BACKGROUND

Networks and network communications facilitate the flow of information between a variety of users. As the network functionality has expanded to encompass multimedia, audio and video application as well as the increased use of complex routed networks, the flow of data over networks has increased significantly. Accordingly, it is vital to ensure that networks operate reliably and efficiently. On method used to encourage network efficiency and reliability is to implement network management applications.

Some network management applications operate under Simple Network Management Protocol (SNMP). SNMP often runs as an isolated application in a network environments. One function of SNMP is to determine device characteristics. This is often accomplished by connecting with and querying port no. 161 of a specific network device. Querying port no. 161 typically allows a SNMP based management application to obtain device specific information provided by the device manufacturer. The SNMP management application may also obtain information from selected management variables available on the network device. Management variable may include information such as in a router, the number of packets switched and the number of packets failed or, in a gatekeeper component, the number of calls attempted and the number of calls that failed.

Such management applications can often prove useful to system administrators in monitoring the network. If a problem occurs within the network, the management variables may be reviewed to troubleshoot the network problem. However, a significant problem with this scenario is that the management application becomes involved only after a problem has arisen and is used primarily as an investigative tool. Such a management tool does not prevent a network problem or error from occurring, it merely helps identify the problem for resolution. Further, such a management tool's identification of the network device is limited to the identification information available.

### SUMMARY

Therefore, a need has arisen for an improved network management tool that facilitates real time management of network devices.

A further need has arisen for a network management tool able to determine device functionality.

In accordance with teachings of the present disclosure, a system and method are described for communicating information that includes multiple network devices that each having at least one network communication port. Each network device is connected to other network device through the communication port. One or more of the network devices is also coupled to an advanced manager through the network device communication port. The advanced manager serves to determine the functionality of the least one network device via the communication port and manage the network device based upon its functionality. More particularly, the advanced manager include a management engine and an associated policy database. The management engine receives inter-device transmission data and inter-device negotiation data and compares the received data with the policy database. The management engine may then direct the network device according to the policy database.

In another aspect the present invention discloses a system for managing network devices including an advanced manager operable to connect with a communication port of a network device. The advanced manager functions to determine the functionality of at least one network device via the communication port and further manages the network device based upon the determined functionality. More particularly, the advanced manager includes an identification engine operable to identify at least one software application running on the network device.

The present invention incorporated a number of important technical advantages. One important technical advantage is providing an advanced manager operable to determine functionality of connected network device through a network device communication port. This allows the network management tool to independently determine the functionality of network device and facilitates real time management of the network device.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a depiction of prior art network manager application;

FIG. 2 is a depiction of a network incorporating an advanced manager according to teachings of the present invention;

FIG. 3 is a depiction of an advanced manager component and network devices negotiating a bandwidth request according to teachings of the present invention; and

FIG. 4 is a depiction of an advanced manager according to the present invention.

### DETAILED DESCRIPTION

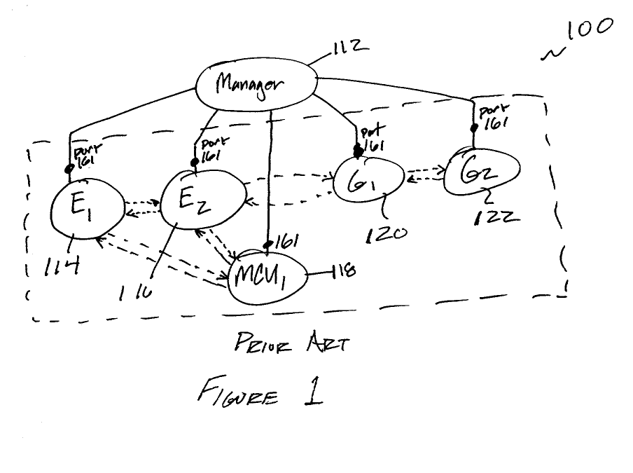

Now referring to FIG. 1, a depiction of a prior art network, depicted generally at 100 is shown for demonstrative purposes. Network 100 includes manager application 112. Manager 112 is connected to a number of interconnected network devices including first end point 114, second endpoint 116, Multipoint Control Unit (MCU) 118, first Gatekeeper 120, and second Gatekeeper 122. The network devices are interconnected via existing communication ports. However, manager 112 connects with the network devices using a port 161 type port. The connection with port 161 of the network devices allows manager 112 to access an identification string existing on the network device as well as management variables that may be accessible through port 161.

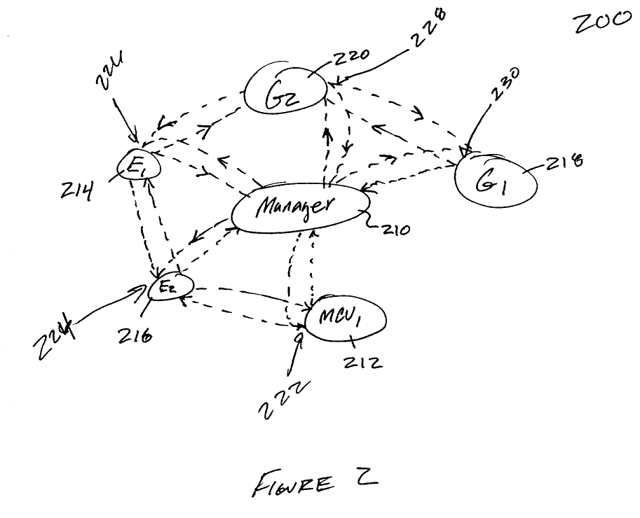

Now referring to FIG. 2, a depiction of a network, depicted generally at 200, incorporating an advanced manager 210 according to the present invention is shown. In the present embodiment, network 200 is a network suitable for transmitting video conference information. Network 200 includes a number of network devices including MCU 212, first endpoint 214, second endpoint 216, first Gatekeeper 218, and second Gatekeeper 220. MCU 212 functions to connect multiple videoconferencing system endpoints, such as first endpoint 214 and second endpoint 216, into a single conference and managing audio and video from each participant within the conference such that group communication is achieved between the multiple endpoints. MCU 212 may also function to code or decode audio and video information according to known standards, such as the H.320, H.323, or H.324 promulgated by the International Telecommunication Union (ITU). Endpoint

In the present embodiment, MCU 212 is operably coupled to second endpoint device 216 such that communication between MCU 212 and second endpoint 216 is facilitated. Similarly, first endpoint device 214 is operably coupled to first endpoint 214 such that communication between first endpoint 214 and second endpoint 216 is facilitated. First endpoint 214 is operably coupled to second gatekeeper device 220 and second gatekeeper device 220 is operably connected to first gatekeeper device 218.

Endpoint devices 214 and 216 may be videoconferencing terminals for capturing audio and video information to be sent to other endpoints in the network. Each endpoint may be operable to capture, process, code, or otherwise format the audio and/or video information in order to be sent as part of a video conference. Endpoint devices 214 and 216 are further operable to receive audio and video information, preferably as part of a video conference, to allow viewing by a user.

Gatekeeper devices 218 and 220 function to provide and facilitate services that enable conferencing to be more reliable and more secure. In some applications, a gatekeeper component may require endpoint terminals to register themselves with the gatekeeper and allow the gatekeeper component to notify other endpoint components of their existence and to control some of the endpoint's activities. Gatekeeper components can also function to direct the operation of MCU devices. For example, a gatekeeper device may direct an MCU to connect particular endpoints, thereby facilitating a conference call.

In the present embodiment, the connection between MCU 212 and second endpoint 216 is preferably made via network communication port 222. First endpoint 214 and second endpoint 216 are operably connected via network communication port 224. First endpoint 216 and second gatekeeper 220 are operably coupled via communication port 226. Second gatekeeper 220 and first gatekeeper 218 are operably coupled via network communication ports 220 and 230. In a particular embodiment, network communication port 222, 224, 226, 228 and 230 are ‘17181’ type ports. The 1718-type port is preferably a registered port for Gatekeeper UDP discovery port according to H.323 standard. The network communication ports 222, 224, 226, 228, and 230 may also comprise a static TCP port such as a 1720 type port which is used during call setup and initiation.

Additionally, advanced manager 210 is also connected with MCU 212 via network communication port 222. Advanced manager 210 is connected to second endpoint 216 via network communication port 224 and to first endpoint 214 via network communication port 226. Also, advanced manager 210 connects to second gate keeper 220 via network communication port 228 and connects to first gatekeeper 218 through network communication port 230. Accordingly, advanced manager 210 has real time access to the network communications of network elements 212, 214, 216, 218, and 220.

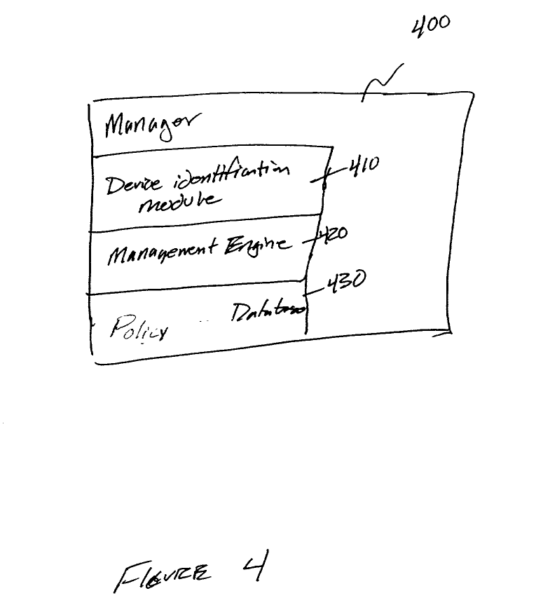

Advanced manager 210 may include a number of different elements, as disclosed in greater detail in FIG. 4, below. In the present embodiment, advanced manager acts to monitor network activities by and between network elements 212, 214, 216, 218, and 220. Because advanced manager 210 is connected with network elements 212, 214, 216, 218, and 220 via the network communication ports which interconnect the network elements, advanced manager may access the real time communication between the network elements, instead of relying on the limited device identification and management variable information available via port 161. However, advanced manager 210 may additionally connect with one or more network elements via port 161.

The connection of advanced manager 210 with the network communication ports 222, 224, 226, 228, and 230 or network elements 212, 216, 214, 220, and 218, respectively enable advanced manager to identify and classify the function of each network element. Initially, when a network environment comes online, each network element preferably performs an initiation procedure that advertises the existence of the network element to connected elements. In the present embodiment, advanced manager 210 receives these initialization communications.

Advanced manager may also query network devices for identification information. Additionally, advanced manager may also classify or identify the functionality of a network device based upon the network transmission characteristics of the network device. This classification may include determining that a network device primarily transmits particular types of transmissions such as an audio stream, video stream, or simple data stream. Advanced manager 210 may then manage these different types of devices according to their transmission characteristics. Advanced manager 210 may also query associate network devices to determine the software applications running on the associated network device. The resulting classification and identification allows Advanced Manager to classify the functionality of each component as well as the relationship of each component.

The present embodiment includes video network 200 for transmitting video conferencing information between network devices. However, the present invention contemplates advanced manager 210 in any suitable network environment. In alternative embodiments, advanced manager 210 may connect to and manage a variety of network components including, but not limited to: gatekeeper devices, MCUs, edge switches (such as ATM edge switches, LAN Emulation servers (LES), and LAN Emulation Configuration Servers.

The present embodiment also discloses advanced manager 210 operably connected to each network device. In alternative embodiments, advanced manager 210 may be connected to the network communication ports of only a portion of the network devices within a network. In additional alternative embodiments, network 200 may include a plurality of interconnected network components which may, in turn, also connected with additional networks.

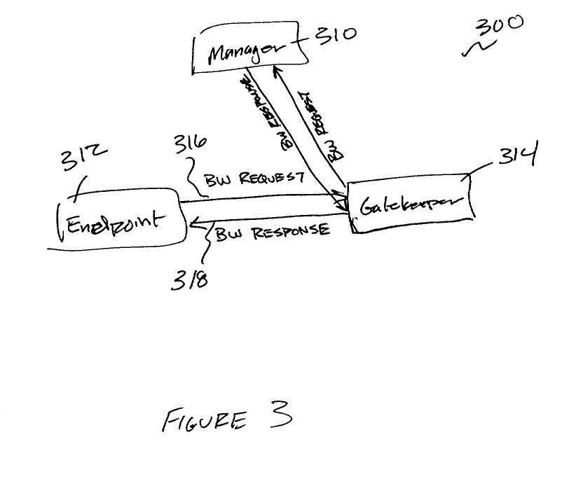

Now referring to FIG. 3 a demonstrative depiction of a bandwidth negotiation in a network, depicted generally at 300, according to the present invention. Network 200 includes endpoint 312 connected with gatekeeper 314. Gatekeeper 314 is also operatively connected with advanced manager 310. Endpoint 312, gatekeeper 314, and advanced manager 310 are preferably interconnected, as described in FIG. 2.

In the present embodiment, advanced manager 310 has preferably previously determined the functionality of endpoint 312 and gatekeeper 314. Endpoint 312 preferably sends bandwidth request 316 to gatekeeper component 314. Gatekeeper component 314 may determine that bandwidth request should be granted or rejected according to existing policy functions incorporated within gatekeeper 314. In the present embodiment, if gatekeeper 314 determines to reject bandwidth request 316, the bandwidth request 316 is submitted to advanced manager 310 for further consideration. Advanced manager 310 may then direct gatekeeper 314 to accept or reject bandwidth request 316 by submitting bandwidth response 318. The process for accepting or rejecting the bandwidth response is described more fully in FIG. 4, below.

In the present embodiment, in the event the gatekeeper 314 initially determines to accept bandwidth request 316, gatekeeper may then submit a positive bandwidth request response 318. One advantage of the present embodiment, is that before a bandwidth request is denied, advanced manager 310 may review the request and determine whether the denial of the request should proceed. This allows for real time management of the network.

Now referring to FIG. 4, a depiction of an advanced manager, depicted generally at 400, is shown. Advanced manager 400 include device identification module 410, management engine 420, and policy database 430. Advanced manager 400 may function as a dedicated hardware device or may be implemented as software on a system such as a PC, server, or work station.

Identification module 410 serves to receive initialization data and network transmission data from associated network devices. Identification module 410 serves to identify the associated devices according to the received initialization and network transmission data. Management engine 420 serves to review and oversee network management decisions within the associated network. For example, management engine 420 may serve to consider the bandwidth request described in FIG. 3. Management engine 420 preferably generates management instructions for associated network devices by comparing received management requests with policy database 430. Policy database 430 preferably includes both generalized network policies as well as device-specific network management policies developed for the network. Additionally, policy database 430 may be selectively edited and updated as network policies. For example, management engine 420 may compare the bandwidth request received in FIG. 3 to policy database to determine whether a policy has been established to allow the bandwidth request. Similarly other policies may include Start Time-End Time for an endpoint to make a call or allowing a selected endpoint to call another selected endpoint.

Although the disclosed embodiments have been described in detail, it should be understood that various changes, substitutions and alterations can be made to the embodiments without departing from their spirit and scope.

What is claimed is:

1. A system for communicating information comprising:
a plurality of network devices each having at least one network communication port, each network device connected with at least one other network device through the at least one network communication port;
an advanced manager operably coupled to the communication port of at least one network device, the advanced manager operable to:
determine the functionality of the least one network device via the communication port; and
manage the at least one network device based upon the determined functionality.

2. The system of claim 1 further comprising:
the advanced manager operably coupled to the network communication port of a plurality of network devices;
the advanced manager having a device identification module operable to determine the functionality of each of the plurality of network devices through transmissions through the network communication port.

3. The system of claim 1 wherein the network communication port further comprises a 1718 type port.

4. The system of claim 1 further comprising the plurality of devices interconnected within a network operable to facilitate video conferencing.

5. The system of claim 1 further comprising:
the advanced manager having a management engine and a policy database;
the management engine operable to receive inter-device transmission data and inter-device negotiation data from at least one network device and compare the received data with the policy database; and
the management engine further operable to direct the at least one network device according to the policy database.

6. The system of claim 5 further comprising the database operable to be selectively updated.

7. The system of claim 5 further comprising the management engine operable to:
receive bandwidth negotiation data and a bandwidth negotiation recommendation from at least one network device;
compare the bandwidth negotiation data and bandwidth negotiation recommendation with the policy database; and
submit a revised bandwidth recommendation based on the policy database.

8. The system of claim 1 further comprising the advanced manager operable to determine a network device to be a Multipoint Control Unit device.

9. The system of claim 1 further comprising the advanced manager operable to determine a network device to be a Gatekeeper device.

10. The system of claim 1 further comprising the advanced manager operable to determine a network device to be a End Point device.

11. The system of claim 1 further comprising the advanced manager operable to:
determine the software applications running on each plurality of network devices;
classify device function based upon the determined software applications.

12. The system of claim 1 further comprising the advanced manager operable to receive selected inter-device communications.

13. A system for managing network devices comprising:
an advanced manager operable to connect with the communication port of at least one network device, the advanced manager operable to:
determine the functionality of the at least one network device via the communication port; and
manage the at least one network device based upon the determined functionality.

14. The system of claim 13 wherein the advanced manager further comprises:
a device identification module operable to determine the functionality of a connected network device;
a management engine operable to receive device identification and network management information;
a policy database containing a plurality of management policies decisions; and
the management engine operable to submit network management instructions an associated network device.

15. The system of claim 14 further comprising the management engine operable to:
receive bandwidth negotiation data and a bandwidth negotiation recommendation from at least one network device;
compare the bandwidth negotiation data and bandwidth negotiation recommendation with the policy database; and
submit a revised bandwidth recommendation based on the policy database.

16. The system of claim 13 further comprising the advanced manager operable to determine the functionality of the least one network device via the 1718 type communication port.

17. The system of claim 13 further comprising the device identification engine operable to identify at least one software application running on the network device.

18. A method for managing network devices comprising:
providing an advanced manager;
identifying and associated network device by connecting with the network communication port of the associated network; and
managing the network device based on the identification of the network device.

19. The method of claim 18 further comprising identifying the software running on the associated network device and identifying the associated network device based upon the identified software.

20. The method of claim 18 further comprising:
receiving network management data;
consulting an associated policy data base; and
submitting management instructions based on the associated policy database.
